(19) United States
(12) Patent Application Publication
(10) Pub. No.: US 2026/0129712 A1
(43) Pub. Date: May 7, 2026

(54) UE-Initiated SpCell Access

(71) Applicant: Apple Inc., Cupertino, CA (US)

(72) Inventors: Amr Abdelrahman Yousef Abdelrahman MOSTAFA, Neuried (DE); Fangli XU, Beijing (CN); Naveen Kumar R PALLE VENKATA, San Diego, CA (US)

(21) Appl. No.: 19/116,448

(22) PCT Filed: Sep. 29, 2022
(86) PCT No.: PCT/CN2022/122764

§ 371 Date: Mar. 28, 2025

(51) Int. Cl. H04W 76/27; H04W 76/30

(52) U.S. Cl. CPC H04W 76/27; H04W 76/30

(57) ABSTRACT

A base station operating as a target. SpCell for a user equipment (UE) receives a message from the UE comprising a UE identity and an SpCell access request, transmits a UE context request comprising the UE identity to a currently serving SpCell and receives a UE context reply from the currently serving SpCell.

### TECHNICAL FIELD

The present disclosure generally relates to wireless communication, and in particular, to UE-initiated SpCell access.

### BACKGROUND

It is expected that connection density in future network deployments (e.g., 6G) will be substantially greater than the density of 4G and 5G networks. Use of existing 4G and 5G RRC connected mode mobility (i.e., handover) methods will be difficult to efficiently and reliably manage in future higher density networking environments.

Future network deployments are likely to utilize high frequency bands, which tend to utilize smaller cell sizes than existing cells operating for 4G and 5G service. Accordingly, the number of User Equipment (UE) transitions between cells will correspondingly increase as average cell size decreases.

Advancements in artificial intelligence (AI) and machine learning (ML) in UEs may improve mobility decision making. For example, a UE has information on its velocity, history of mobility decisions on commonly used routes, and cell quality predictions based on measurements.

The Radio Resource Control (RRC) protocols for 4G and 5G have multiple procedures utilized for achieving the same Outcome but by different means. This increases the RRC layer complexity.

### SUMMARY

Some exemplary embodiments are related to a method performed by a base station operating as a target SpCell for a user equipment (UE)/The method includes receiving a message from the UE comprising a UE identity and an SpCell access request, transmitting a UE context request comprising the UE identity to a currently serving SpCell and receiving a UE context reply from the currently serving SpCell.

Other exemplary embodiments are related to a method performed by a user equipment (UE). The method includes transmitting a first message to a target SpCell, the first message comprising a UE identity and an SpCell access request, receiving a second message from the target SpCell, wherein the second message is ciphered and integrity protected using a source SpCell security context, deciphering and integrity verifying the second message and performing an operation indicated in the second message.

Still further exemplary embodiments are related to a method performed by a user equipment (UE), wherein the UE has an established Access Stratum (AS) context with a target SpCell. The method includes transmitting a message to the target SpCell, the message comprising a UE identity and an SpCell access request and receiving an SpCell access response indicating the target SpCell is now the serving cell for the UE.

### BRIEF DESCRIPTION OF THE DRAWINGS

FIG. 1 shows an exemplary network arrangement. according to various exemplary embodiments.

FIG. 2 shows an exemplary UE according to various exemplary embodiments.

FIG. 3 shows an exemplary base station according to various exemplary embodiments.

FIG. 4 shows a call flow diagram depicting RRC based UE-initiated SpCell Access according to various exemplary embodiments.

FIG. 5 shows a call flow diagram depicting improved UE-initiated SpCell Access when UE context retrieval fails according to various exemplary embodiments.

FIG. 6 shows a call flow diagram depicting improved UE-initiated SpCell Access when a source SpCell decides to release the RRC connection according to various exemplary embodiments.

FIG. 7 shows a call flow diagram depicting improved UE-initiated SpCell Access during mobility according to various exemplary embodiments.

FIG. 8 shows a call flow diagram depicting improved UE-initiated SpCell Access when a message from a UE integrity verification for a target SpCell fails according to various exemplary embodiments.

FIG. 9 shows a call flow diagram depicting improved UE-initiated SpCell Access when UE verification by a source SpCell fails according to various exemplary embodiments.

FIG. 10 shows a call flow diagram depicting full network control for RRC Connected Mode Handover/PSCell Change according to various exemplary embodiments.

FIG. 11 shows a call flow diagram depicting partial network control for RRC Connected Mode Handover/PSCell Change according to various exemplary embodiments.

FIG. 12 shows a call flow diagram depicting fully flexible control for RRC Connected Mode Handover/PSCell Change according to various exemplary embodiments.

FIG. 13 shows a call flow diagram depicting RRC Connected Mode Handover/PSCell Change according to various exemplary embodiments.

FIG. 14 shows a call flow diagram depicting an RRC connection resume without AS-context established between a UE and a target SpCell according to various exemplary embodiments.

FIG. 15 depicts a call flow diagram for random access-based VE-Initiated SpCell Access according to various exemplary embodiments.

FIG. 16 depicts a call flow diagram for random access based UE-Initiated SpCell Access when a network is highly loaded and cannot serve a UE according to various exemplary embodiments.

FIG. 17 depicts a call flow diagram for random access-based UE-Initiated SpCell Access for connected mode handover/PSCell Change according to various exemplary embodiments.

FIG. 18 depicts a call flow diagram for random access-based UE-Initiated SpCell Access for RRC Connection Reestablishment/Recovery according to various exemplary embodiments.

FIG. 19 depicts a call flow diagram for random access-based UE-Initiated SpCell Access for RRC connection resume according to various exemplary embodiments.

### DETAILED DESCRIPTION

The exemplary embodiments may be further understood with reference to the following description and the related appended drawings, wherein like elements are provided with the same reference numerals. The exemplary embodiments relate to improved UE-initiated SpCell access. A Special Cell (SpCell) may refer to a Primary Cell (PCell) of a primary cell group (PCG) or a Primary Secondary Cell (PSCell) of a secondary cell group (SCG).

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol, or any other type of network.

It should be understood that the term “UE Access Stratum (AS) Context” refers to information that is used by the UE operating in an RRC connected mode to exchange data with the cellular network. Exemplary types of this information include the AS security context, Radio Bearer (RB) (PDCP) and Radio Link Control (RLC) configurations, measurement configurations, physical layer configurations, and Medium Access Control (MAC) configurations.

The purpose of existing UE to target SpCell techniques (connection resume, reestablishment, handover) is to have a connection with “active Access Stratum (AS)-Context” with a target SpCell while maintaining a UE-context on the network side. At issue is that the various existing schemes increase RRC protocol complexity. Each existing scheme has various drawbacks relevant to its specific use case. The existing schemes are not optimized for the case where a target SpCell AS-context is already active.

The exemplary embodiments include a proposed RRC procedure called “UE-Initiated SpCell Access.” This procedure may be used for a UE connection with a target SpCell (e. g., having an active AS-Context for target SpCell that is being used for data transfer) while maintaining a UE Context on the network side. Exemplary scenarios where this procedure may be used are in 4G/5G handover/PSCell Change/connection Reestablishment/Connection Resume, etc. However, it should be understood that the exemplary embodiments are not limited to these scenarios.

Improvements in RRC signaling to target SpCells will lead to more efficient management during connected mode mobility operations in high density and/or high mobility scenarios. Additional benefits include reduced signaling overhead, reduced latency, reduced RRC protocol complexity, and greater connection reliability.

Reduction of the RRC layer complexity will benefit multiple signaling operations. Connection reestablishment procedures may be simplified to be limited to suitable PCell cell selection. Connection suspend/resume procedures may be simplified to be limited to AS-Context storing/restoring and AS-Context maintenance in an active state. Connected mode mobility related measurement reports may no longer be required at least in intra-RAT connected mode mobility use cases, Handover commands from the network could be limited only for blind or inter-radio access technology (IRAT) handovers. Conditional handovers/PSCell Change may be completely removed or simplified to only maintaining AS-Contexts of target SpCells.

The exemplary embodiments may be understood to encapsulate three primary use cases: case 1—No AS-Context established between the UE and the target SpCell, case 2—AS-Context established and active between the UE and the target SpCell, and case 3—-AS-Context established and inactive between the UE and the target SpCell.

Case 1 may be understood to occur via RRC Signaling, whereas cases 2 and 3 are Random Access (RA) based. A first aspect of the exemplary embodiments may apply to the scenario in case 1, whereas a second aspect of the exemplary embodiments may apply to cases 2 and 3.

In case 1, where there is no AS-Context established between the UE and the target SpCell, the UE lacks any AS-Context dedicated configurations for the target SpCell. Thus, in case 1, the target SpCell lacks any context information about the UE.

In case 2, the AS-Context is established and active between the UE and the target SpCell. In a handover (e.g., PSCell Change) operation, the target SpCell is one of the configured serving cells. In a connection reestablishment procedure, the target SpCell is the last serving PCell or one of the configured serving cells. In dual connectivity (DC), the UE may have two active AS-contexts for both the Primary Cell Group (PCG) and Secondary Cell Group (SCG).

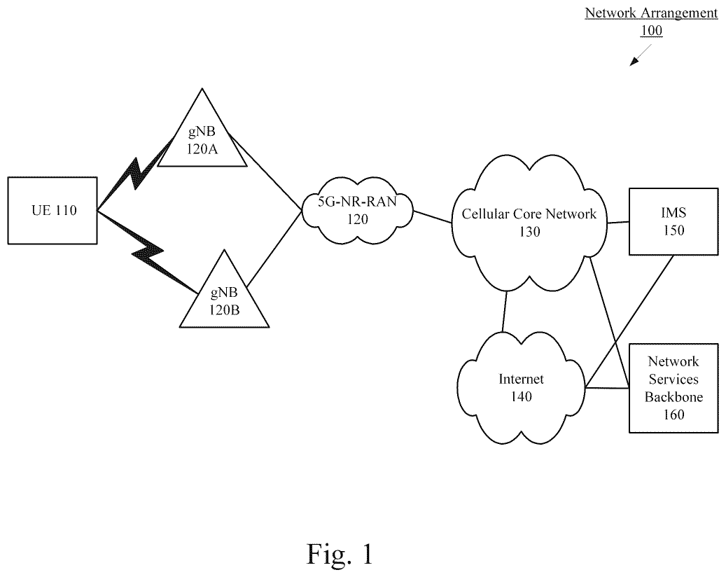

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e. g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc. ) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A and gNB 120B. However, reference to a gNB is merely provided for illustrative purposes, any appropriate base station or cell may be deployed (e.g., Node Bs, eNodeBs, HeNBs, eNBs, qNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., qNB 120A or qNB 120B).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

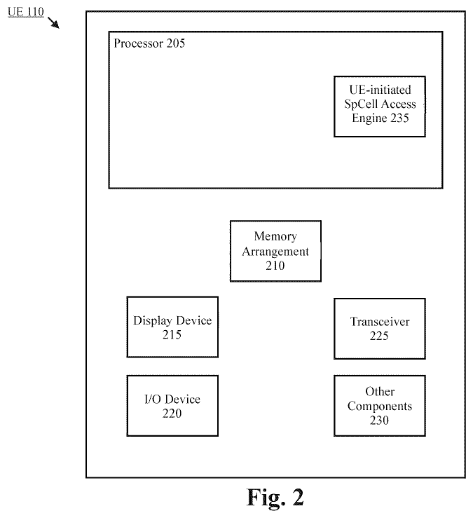

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a UE-initiated SpCell Access engine 235 for performing operations such as the newly proposed “UE-initiated SpCell access” RRC procedure. Examples of these operations will be described in greater detail below.

The above referenced engine being an application (e. g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies). For example, the transceiver 225 may operate on the unlicensed spectrum when e.g., NR-U is configured.

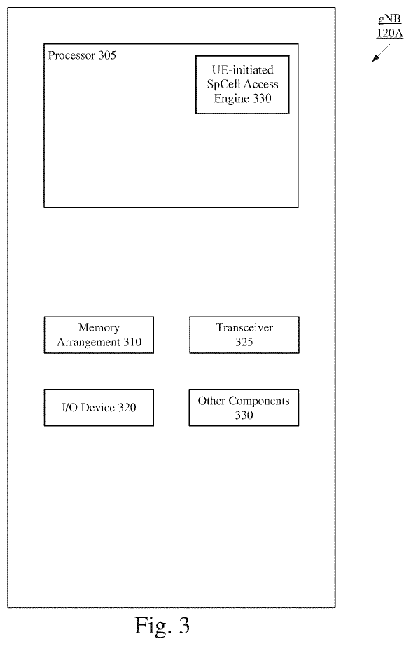

FIG. 3 shows an exemplary base station 300 according to various exemplary embodiments. The base station 300 may represent the gNB 120A or qNB 120B or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a UE-initiated SpCell access engine 330 for performing operations including signal handling to a source SpCell/target SpCell/UE. Examples of these operations will be described in greater detail below.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

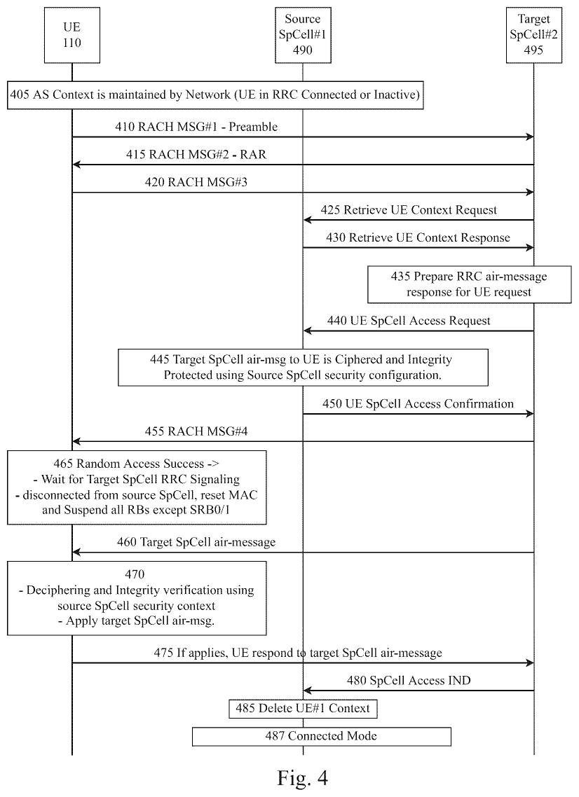

FIG. 4 shows a call flow diagram depicting RRC based UE-initiated SpCell Access according to various exemplary embodiments. The call flow include the UE 110, a source SpCell 490 and a target SpCell 495. As described above, in a first aspect of the exemplary embodiments, the UE 110 requires a connection with the target SpCell 495 and there is no AS-Context established between the UE 110 and the target SpCell 495. The context of the UE 110 is maintained on the network side by the last serving SpCell. In a first variant of the first aspect of the exemplary embodiments, improved UE-initiated SpCell access operations are disclosed. It should be further understood that if retrieval of the context of the UE 110 by the SpCell fails, e.g., due to the context not being maintained by the network, a fallback to legacy connection setup procedures may be performed instead of the first aspect.

In 405, the UE 110 is in an RRC Connected or Inactive sate with the source SpCell 490. At this time, the UE 110 has no AS-Context established between itself and the target SpCell 495, e.g., the target SpCell 495 has no context information for the UE 110 (configurations, capabilities, security context).

In 410, the UE 110 transmits a preamble random access channel (RACH) message to the target SpCell 495. In 415, the target SpCell 495 responds to the UE 110 with a re-authorization request (RAR), also via RACH. It may depend on the specific implementation on UE 110 to perform the RA procedure without being disconnected from the source SpCell 490, if possible. One of skill in the art will understand that this may occur via features such as dual active protocol stack (DAPS), free RFs that can operate in parallel to the source SpCell 490 activities, autonomous gaps, or using connected mode discontinuous reception (CDRX) inactive time. In some exemplary embodiments, special (e.g., different from normal connection establishment RA resources but still broadcast in SIBs) RA resource configurations may be used for mobility purposes for the messages in 410 and 415.

In 420, the UE 110 transmits a RACH message 3 to the target SpCell 495. This message contains UE identifying information and further includes an SpCell Access request with Medium Access Control (MAC) or RRC signaling a “RRCSpCellAccessRequest”. Multiple variations of this identification message are possible. Optionally, the UE 110 may include the cause of the procedure initiation in the message (e.g., handover/reestablishment/resume).

In another option, Integrity Code (e.g., similar to short MAC-I in 4G/5G) may be calculated using the source SpCell 490 AS security configurations. Integrity Codes can verify basic UE 110 information related to SpCell Access procedures. This avoids wasting radio resources for messages being sent by false UEs (assuming that the UE 110 Context Retrieval is successful).

In a first option of the message 420, the UE 110 transmits information identifying the UE sufficiently such that the target SpCell 495 can retrieve the UE context from the source SpCell 490. As an example, the source SpCell 490 CGI and CRNTI, may be referred to as the “Long AS-Identity”. In a second option of the message 420, a new MAC CE called “UE-initiated SpCell access” may be used, containing the “Long AS-Identity”.

In 425, the target SpCell 495 transmits a request to retrieve the UE 110 context information from the source SpCell 490, based on the UE identity provided in the message 420 (such as the Long AS Identity). In 430, the source SpCell 490 responds to the target SpCell 495 with the retrieved UE 110 context. The target SpCell 495 now has the UE 110 context.

In 435, the target SpCell 495 prepares an RRC message called SpCellAccess in response to the request of UE 110. The message may take the form of one or more RRC (re) configurations. The SpCellAccess message 435 contains all relevant configurations and information needed for the UE 110 to establish an AS context with the target SpCell 495.

In 440, the target SpCell 495 sends the prepared UE SpCellAccess request to the source SpCell 490. Included in the request is the UE 110 AS identity. The message may be in a transparent container (e.g., without ciphering or integrity protection).

In 445, the source SpCell 490 ciphers and integrity protects the SpCellAccess request from the target SpCell 495 using the currently active security configuration (the source SpCell 490 security configuration). The source SpCell 490 keys may not be provided to the target SpCell 495.

In 450, the source SpCell 490 responds to the target SpCell 495 by confirming the SpCellAccess request. This message is both ciphered and integrity protected, as described with respect to the security operation described at 445. The source SpCell 490 stops further communication with the UE 110 and forwards user-plane data to the target SpCell 495. The response 450 includes information associated with the RBs of UE 110.

In 455, the target SpCell 495 sends a RACH message to the UE 110. Included in this message are a ContentionResolution MAC control element (CE) having the same value as the message described in the message 420. Alternatively, the ContentionResolution MAC may match a UE-initiated SpCell Access MAC CE.

In 460, the target SpCell 495 transmits an SPCellAccess message to the UE 110 via RRC. It should be noted that this message is ciphered, and integrity protected with the source SpCell 490 AS-Context configuration, as described with respect to the security operation 445. It should be understood that the SpCellAccess message 460 may be included with the message 455, or it may be transmitted as soon as possible after transmission of the message 455. At the conclusion of the message 460, the UE 110 considers the target SpCell 495 to be the new source SpCell, but for the purposes of clarity, the naming scheme of the source SpCell 490 and the target SpCell 495 as described above will continue below.

Upon receipt of the messages 455 and 460, the UE 110 performs operations 465, The operations 465 include disconnecting from the source SpCell 490, resetting MAC, and suspending all radio bearers (RBs), except SRB0/1. The operations 465 may also include deciphering and integrity verification using the source SpCell 490 security context and applying the target SpCell message 460 (RRCSpCellAccess).

Included in this application of the target SpCell message 460 is application of any RRC configurations, security configurations, and RB reset/resume.

In 470, the UE 110 responds to the target SpCell 495 (e.g., RRCSpCellAccessComplete). The response message is ciphered and integrity protected using the target SpCell 495 security configurations.

In 475, the target SpCell 495 indicates to the source SpCell 490 that the SpCell access procedure is completed. In 480, the source SpCell 490 deletes the device context of the UE 110. In 485, the UE 110 and target (now source) SpCell 495 operate in a connected mode.

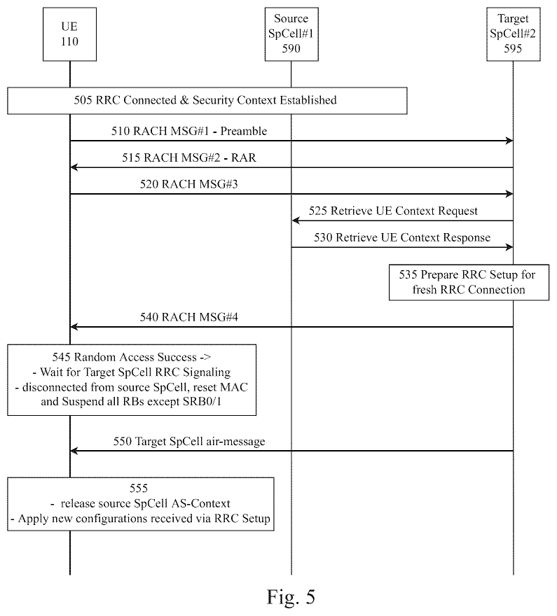

FIG. 5 shows a call flow diagram depicting improved UE-initiated SpCell Access when UE context retrieval fails according to various exemplary embodiments. In a second variant of the first aspect, if the target SpCell 595 fails to retrieve the UE 110 context, then a new connection may be established with the UE 110 via an RRC setup message sent via a common control channel (CCCH) channel on signaling radio bearer 0 (SRB0).

Initially, 505-525 proceed identically to 405-425 described above and therefore will not be described again. In 530, the source SpCell 590 fails to retrieve the UE 110 device context in response to the UE 110 context retrieval message 525.

In 535, the target SpCell 595 prepares an RRC setup for a fresh RRC connection, in response to the failure to retrieve the UE 110 device context in 530. In 540, the target SpCell 595 transmits a RACH message to the UE 110 that is substantially similar to the message described for the message 455.

The operations 545 are then performed by the UE 110. These operations 545 include the UE 110 waiting for further target SpCell 595 RRC signaling, disconnecting from the source SpCell 590, resetting MAC, and suspending all RBs except SRB0/1.

In 550, the target SpCell transmits an RRC setup message via a non-secured channel (e.g., SRB0 CCCH). In 555, the UE 110 releases the source SpCell 590 AS context and applies the new configurations received via RRC setup in 550.

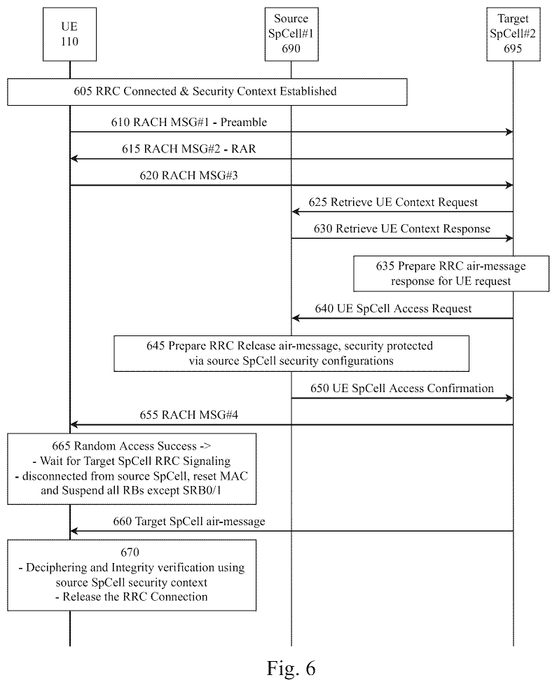

FIG. 6 shows a call flow diagram depicting improved UE-initiated SpCell Access when a source SpCell decides to release the RRC connection according to various exemplary embodiments. In a third variant of the first aspect, a source SpCell may decide to release the RRC connection. As an example, this may occur when no further data transfer is required to the UE 110.

605-640 proceed in a substantially similar manner to that discussed with respect to 405-440. In 645, the source SpCell 690 prepares an RRC release message, which is security protected with the security configurations of source SpCell 690.

In 650, the source SpCell transmits the response message 650 to the target SpCell 695. This RRC UE SpCell Access confirmation message causes the source SpCell 690 to release the connection with the UE 110. The message 650 may be ciphered and integrity protected with the security configurations of the source SpCell 690.

The operation 655 is substantially similar to the operation 455, and that 665 is substantially similar to 465. It should be noted that 660, unlike 460, is a message indicating RRC release rather than RRC SpCell Access. The message 660 may be ciphered and integrity protected using the source SpCell security context and sent to the UE 110.

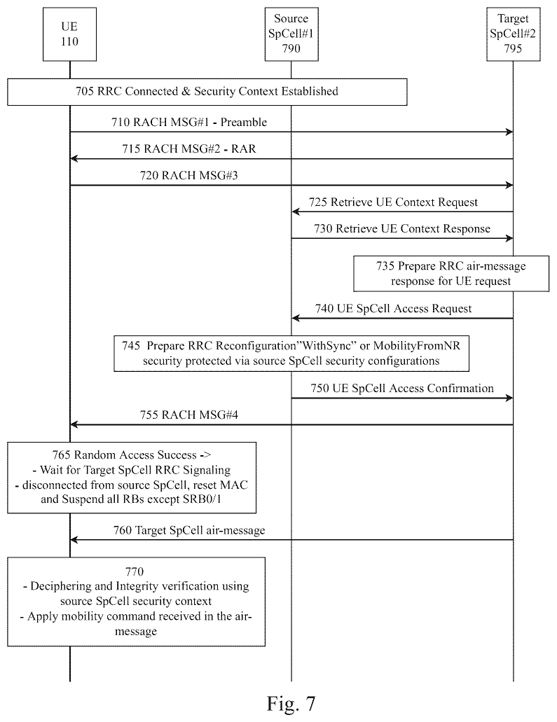

FIG. 7 shows a call flow diagram depicting improved UE-initiated SpCell Access during mobility according to various exemplary embodiments. In a fourth variant of the first aspect, at 705, the UE 110 is operating in an RRC connected state with a security context established. The UE 110 may begin the call flow diagram having met some mobility criteria needed to move to the target SpCell 795. Additionally, the UE 110 has access information available on target SpCell 795.

710-740 proceed in a substantially similar manner as discussed with respect to 410-440. At 745, the source SpCell 790 prepares an RRC ReconfigurationWithSync or MobilityFromNR message. The message may be security protected with the source SpCell 790 security configurations.

In 750, the source SpCell 790 transmits a UE SpCell Access Confirmation to target SpCell 795, which includes the prepared RRC ReconfigurationWithSync/MobilityFromNR message from 745. The message is ciphered and integrity protected by the Source SpCell security parameters. 755 is substantially similar to 455. Operation 765 is substantially similar to 465 described above.

In 760, the target SpCell 795 transmits a message to the UE 110 containing the RRCReconfigurationWithSync/MobilityFrom NR message. This message may be ciphered, and security protected using the source SpCell 790 security context.

In 770, the UE 110 deciphers and integrity verifies the received message 760. The UE 110 applies the mobility command received in the message 760.

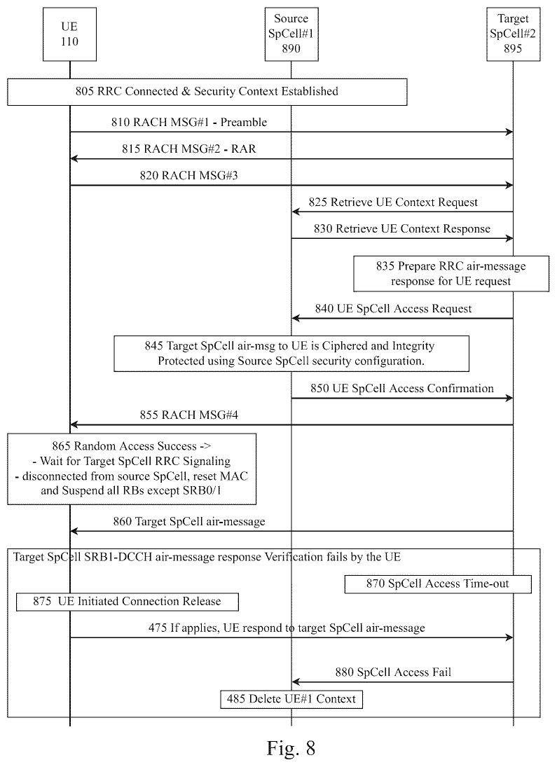

FIG. 8 shows a call flow diagram depicting improved UE-initiated SpCell Access when a message from a UE integrity verification for a target SpCell fails according to various exemplary embodiments. In a fifth variant of the first aspect, in 805, the UE a is operating in an RRC connected state with a security context established. Again, the UE 110 begins the call flow diagram having met some mobility criteria needed to move to the target SpCell 895. Additionally, the UE 110 has access information available on target SpCell 895. 810-860 proceed in a substantially similar manner as 410-460. Unlike what occurs in 465, FIG. 8 depicts what happens if the UE 110 integrity verification of the message 860 fails.

In 865, an SpCell Access timeout occurs at the target SpCell 895. In 875, UE 110 releases the RRC connection with the source SpCell 890. In 880, the target SpCell 895 sends an RRC message to the source SpCell 890 indicating that SpCell access has failed. In 885, the source SpCell 890 deletes the UE 110 device context.

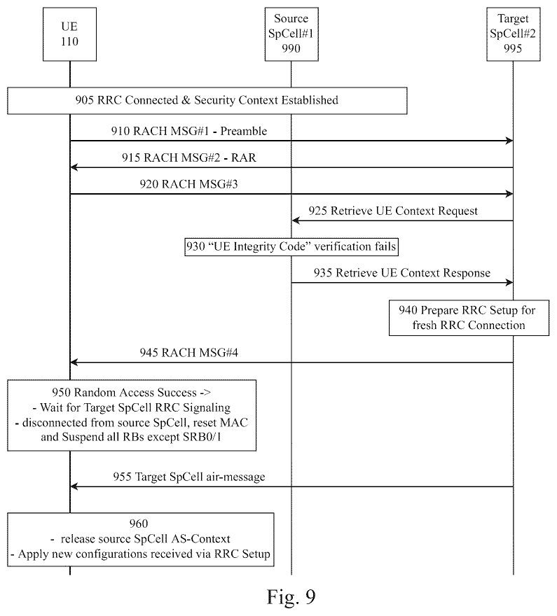

FIG. 9 shows a call flow diagram depicting improved UE-initiated SpCell Access when UE verification by a source SpCell fails according to various exemplary embodiments. In a sixth variant of the first aspect, in 905, UE 110 begins in an RRC connected state with a security context established with the source SpCell 990. Some criteria to move to the target SpCell 995 have been fulfilled and the initial access information on the target SpCell 995 is also available to the UE 110.

910 and 915 proceed in a substantially similar manner to 410 and 415 discussed above. In 920, the UE 110 transmits a RACH message to the target SpCell 995. This message contains UE 110 identifying information and further includes an SPCell Access request with Medium Access Control (MAC) or RRC signaling a “RRCSpCellAccessRequest”. Additionally, the message 920 may include a “UE integrity code”.

In 925, the target SpCell 995 transmits a UE context request message to the source SpCell 990. Included in this message may be the UE 110 AS identity, as well as the UE integrity code. In this scenario, in 930, the integrity verification at the source SpCell 990 fails.

In 935, the source SpCell 990 transmits a retrieved UE context response indicating failure to verify the UE 110 integrity code to the target SpCell 995. In 940, the target SpCell 995 prepares an RRC setup for a fresh RRC connection in response to the failure indication message 935.

In 945, the target SpCell 995 sends a RACH message to the UE 110. Included in this message are a ContentionResolution MAC control element (CE) having the same value as the message described in the message 920. Alternatively, the ContentionResolution MAC may match a UE-initiated SpCell Access MAC CE.

In 950, the UE 110 waits for further RRC signaling from the target SpCell 995. Additionally, the UE 110 disconnects from the source SpCell 990, resets MAC, and suspends all RBs except for SRB0/1.

In 955, the target SpCell 995 sends an RRC setup message to UE 110 via a non-secured channel (e.g., SRB0 CCCH channel). In 960, the UE 110 releases the source SpCell 990 AS-Context. Additionally, the UE 110 applies the newly received RRC configurations from 945.

It should be understood that in case 1, where there is no AS-Context established between the UE and target SpCell, is achieved via RRC signaling. Further disclosure is provided for further variants of the first aspect (which apply to case 1).

In the seventh variant of the first aspect of the exemplary embodiments, the UE should trigger Handover/PSCell Change to a target SpCell despite there being no AS-Context established for the target SpCell, and there should be no required information to be transferred or received from the source SpCell.

The proposed seventh variant features several differences as compared to existing handover/PSCell Change. The first difference is that all signaling (including RRC configurations) is exchanged directly with the target SpCell, which may have more reliable channel conditions than the source SpCell. This leads to greater reliability and lower latency. The second change is that there is no need for measurement reports (e.g., reduced signaling overhead). The third change compared to existing methods occurs on the network side—the target SpCell initiates the UE handover from the Source SpCell instead of the other way around.

Comparing existing Conditional Handover (CHO)/Conditional PSCell Change (CPC) methods to the proposed seventh variant, the target SpCell(s) pre-preparation for handover/PSCell Change on the network side are no longer needed, nor are the candidate target SpCells RRC Reconfigurations messages on the UE side needed. Additionally, signaling is reduced, complexity is reduced, scalability is increased, and resources utilization efficiency on both UE and network side is increased.

In the seventh variant, a list of candidate target SpCells may be configured by the network. This list of candidate target SpCells may be associated with execution conditions for each of the target SpCells. Additionally, this list of candidate target SpCells may feature common configurations required for initial access to the cellular network.

Optionally, it may be left to specific UE implementation as how to acquire required information for target SpCell initial access (if the information is not provided by the network) and perform a RA procedure without being disconnected from a source SpCell. For example, via a Dual Active Protocol Stack (DAPS) feature, free RF can operate in parallel to source SpCell activities, autonomous gaps, and during CDRX inactive time.

The seventh variant may be understood to cover all connected mode non-blind intra RAT handover use cases where the target SpCell AS context is not established. With the expected increase in cells and connection density in future cellular deployments, both normal and conditional mobility schemes will not be an option for controlling UE mobility in connected mode due to the drawbacks addressed above.

Improved handover reliability by avoiding early/late handover UCs may be achieved by using AI/ML on the UE side, which may reduce the likelihood of wrong decisions by use of UE-specific parameters (e.g., location, moving direction, speed, route) and not only cell power values. Networks may adjust mobility configurations and thresholds towards late handover/PSCell Change because there is no need to exchange information with a source SpCell.

Several options of the seventh variant of the first aspect of the exemplary embodiments are disclosed herein. In a first option, the network fully controls the signaling procedure. The network may have a list of candidate target SpCells. The list may be associated with configurations required for initial access, and the list may be prioritized based on some predefined criteria. Each candidate target SpCell may have execution conditions represented via measurement IDs.

In the first option, the target SpCell execution condition is fulfilled if all measurement IDs associated with the target candidate SpCell are fulfilled. The execution may be guarded by an RRC timer, What happens upon expiration of the RRC timer depends on the status of the source SpCell connection. If the connection, is not broken then the UE may remain on the source SpCell, otherwise the UE may initiate a recovery procedure (e.g., MCG connection/establishment/SCG failure).

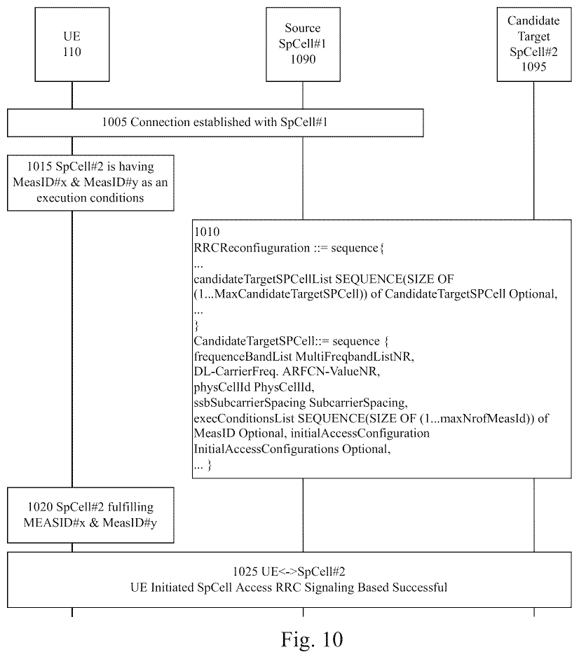

FIG. 10 shows a call flow diagram depicting full network control for RRC Connected Mode Handover/PSCell Change according to various exemplary embodiments. In 1005, the UE 110 establishes a connection with a source SpCell 1090. As part of the connection establishment, the UE 110 indicates to the network its capabilities (including its support of the first option described above).

In 1010, the network configures the source SpCell 1090 and candidate SpCell 1095 with a candidate target SpCell list for the UE 110. This list may also contain information about the cell(s) such as frequency IDs, spacing, and an execution condition list. Optionally, the list 1015 may include the initial access configurations for the candidate target SpCell(s). The UE 110 is also provided with this list.

In 1015, it is shown that each candidate target SpCell has execution conditions represented via Measurement IDs. In this example, it may be considered that the target SpCell 1095 is associated with MeasID # X and MeasID # Y.

Once the UE 110 receives the list 1015, the UE 110 monitors the candidate target SpCells contained in the received list 1015. For example, in 1020, it may be considered that one or more measurement ID conditions are fulfilled. The UE 110 may now initiate mobility operations with the target SpCell that fulfilled the condition(s).

In 1025, the UE 110 and the candidate SpCell 1095 perform the UE-initiated SpCell Access procedure described with respect to FIG. 4.

In a second option of the seventh variant of the first aspect, partial network control of RRC Connected Mode Handover/PSCell Change is disclosed. In the second option, the network may have a list of candidate target SpCells. The list may be associated with configurations required for initial access, and the list may be prioritized based on some predefined criteria. There is no specific execution condition per candidate SpCell.

In the second option, if the condition for the candidate target SpCell fulfilled, the UE 110 may start the UE-initiated SpCell Access procedure described with respect to FIG. 4. This criteria may be based on configurations received from the network defining SpCell Access criteria, suitability criteria based on configurations received in SIBs, or any other method defined by industry standards.

The execution may be guarded by an RRC timer. What happens upon expiration of the RRC timer depends on the status of the source SpCell connection. If the connection, is not broken then the UE may remain on the source SpCell, otherwise the UE may initiate a recovery procedure (e. g., MCG connection Restablishment/SCG failure).

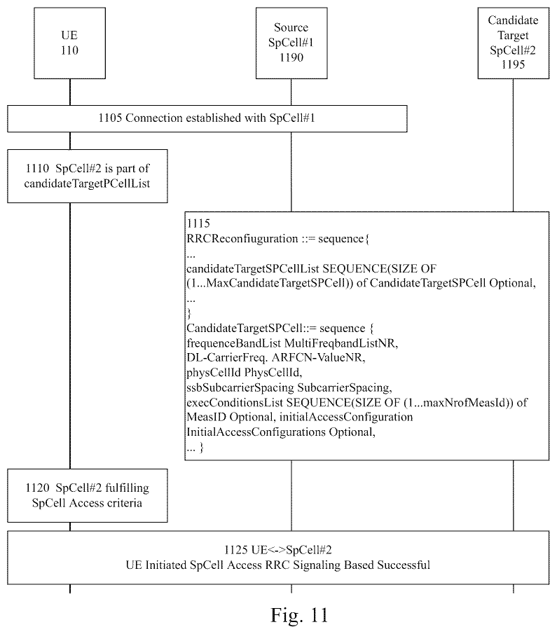

FIG. 11 shows a call flow diagram depicting partial network control for RRC Connected Mode Handover/PSCell Change according to various exemplary embodiments. In 1105, the UE 110 establishes a connection with a source SpCell 1190. In 1110 the UE 110 recognizes that the candidate SpCell 1195 is part of a candidate target SpCell list. The UE 110 recognizes this because in 1115, the network configures the source SpCell 1090 and the candidate SpCell 1095 with a candidate target SpCell list which is sent via RRC signaling to the UE 110. This list may also contain information about the cell(s) such as frequency IDs, spacing, and an execution condition list. Optionally, the list 1115 may include the initial access configurations for the candidate target SpCell(s). In this example, the list 1115 may not include the measurement ID conditions as described with respect to FIG. 10.

In 1120, it may be considered that the candidate target SpCell 1195 access criteria have been fulfilled. The UE 110 then begins the UE-initiated SpCell access procedure described with respect to FIG. 4.

In a third option of the seventh variant of the first aspect, fully flexible RRC Connected Mode Handover/PSCell Change is disclosed. Unlike the previously described first and second options of the seventh variant, there are no candidate SpCell lists nor execution conditions provided to the UE 110. The execution condition is determined at the UE 110.

If a candidate target SpCell fulfills the SpCell access criteria, the UE 110 may start the “UE-Initiated SpCell Access” procedure described with respect to FIG. 4. The SpCell access criteria may be based on configurations received from the network defining SpCell access criteria or could be as based on suitability criteria based on configurations received in SIBs (e.g., SIB1 in NR), or by any other method defined by industry standards. The execution may be guarded by an RRC timer. What happens upon expiration of the RRC timer depends on the status of the source SpCell connection. If the connection is not broken, then the UE may remain on the source SpCell, otherwise the UE may initiate a recovery procedure (e.g., MCG connection Restablishment/SCG failure).

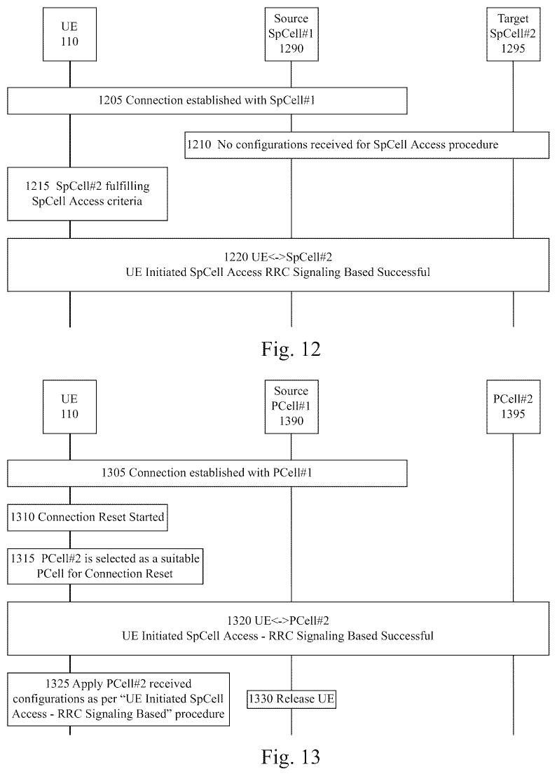

FIG. 12 shows a call flow diagram depicting fully flexible control for RRC Connected Mode Handover/PSCell Change according to various exemplary embodiments. In 1205, UE 110 establishes a connection with source SpCell 1290. Unlike the first and second options, the UE 110 does not receive configurations from the network at 1210 (including both source SpCell 1290 and target SpCell 1295).

In 1215, the UE 110 determines that target SpCell 1295 fulfils the SpCell access criteria. The UE 110 then initiates the SpCell access procedure with the SpCell 1295 as described above with respect to FIG. 4.

In an eighth variant of the first aspect of the exemplary embodiments, RRC connection reestablishment in case 1 (no UE AS-context established between the UE 110 and target SpCell) is disclosed. In the eighth variant, a UE may reestablish connection with a target SpCell without having an AS-context established with the target SpCell and without the need to perform explicit security authentication between the UE and the target SpCell. It should be understood that the eighth variant can be applied to all types of RRC connection reestablishment procedures where the target SpCell AS-context is not yet established.

Simplifying the RRC connection reestablishment complexity may be achieved by reducing the number of RRC messages exchanged between the network and the UE to complete the RRC connection reestablishment, as well as the processing required by the UE and network to complete the procedure.

There are no configurations required for the eighth variant of the first aspect. The execution conditions of the eighth variant may be understood to occur when the UE 110 finds a suitable SpCell to be selected for connection reestablishment.

The execution procedure of the eighth variant may be the initiation of UE-initiated SpCell access procedure as described FIG. 4. The entire procedure is completed using only three RRC signaling messages as compared to the five needed according to existing implementations. The execution may be guarded by an RRC timer, Upon expiration of the timer, the UE considers the RRC Connection reestablishment procedure fails and initiates the RRC Connection Release procedure.

FIG. 13 shows a call flow diagram depicting RRC Connected Mode Handover/PSCell Change according to various exemplary embodiments. In 1305, the UE 110 establishes a connection with the source SpCell 1390. In 1310, an event occurs that requires a connection reset.

In 1315, the UE 110 selects the SpCell 1395 as a suitable SpCell for a connection reset. The selection may be based on any mobility condition being satisfied for the target SpCell 1395. In 1320, the UE 110 initiates the SpCell access procedure with the SpCell 1395 as described above with respect to FIG. 4. It should again be noted that only three RRC signaling messages are required to be exchanged with the network to complete the entire procedure.

In 1325, the UE 110 applies the SpCell 1395 received configurations as per the procedure described with respect to FIG. 4. In 1330, the source SpCell 1390 releases the UE 110.

In a ninth variant of the first aspect, a UE may perform an RRC connection resume operation with a target SpCell without having an AS-context established with the target SpCell and without having security configurations established (e.g., via NextHopChangingCount received in Suspend Configuration) for the target SpCells. The ninth variant may be applied to all types of RRC resume procedures where AS-context is not established.

A reduction in RRC resume complexity allows for reuse of the same procedures described herein for handovers and connection reestablishment. The complexity reduction also eliminates the need for security establishment with the target SpCell (e.g., via nextHopCount) during the connection suspend.

There are no configurations needed to perform the operations of the ninth variant. The execution condition for the ninth variant arises when connection resumption is used. Within the “UE-initiated SpCell Access” procedure the target SpCell AS-context would be received from the target SpCell and security protected via the last serving SpCell AS-context security configurations. Execution may be guarded by an RRC timer. If the timer expires, the UE may consider the connection resume operation as failed and may initiate a connection release.

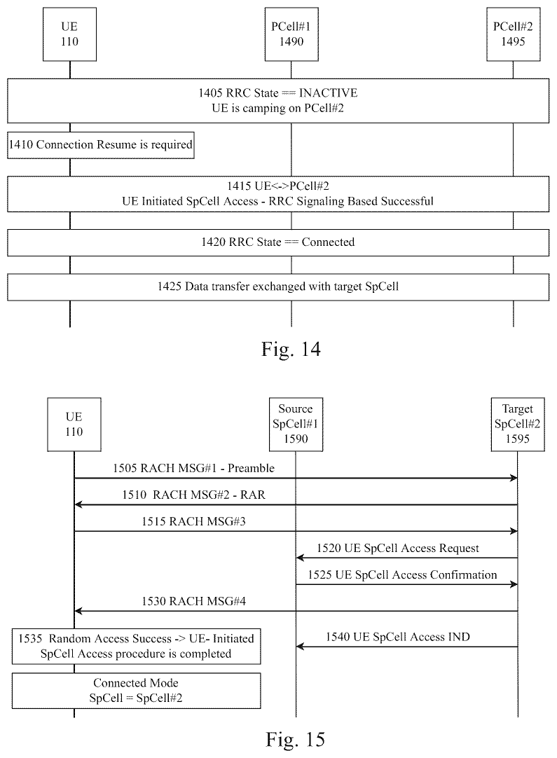

FIG. 14 shows a call flow diagram depicting an RRC connection resume without AS-context established between a UE and a target SpCell according to various exemplary embodiments. In 1405, the UE 110 is operating in an inactive state and is camping on the target PCell 1495. In 1410, a connection resume is required. The reason for the connection resume may be any condition requiring the connection to be resumed.

In 1415, the UE 110 performs the UE-initiated SpCell Access procedure described with respect to FIG. 4. In 1420, the UE 110 is operating in an RRC connected state with the target PCell 1495. In 1425, the UE 110 begins data transfer with the target PCell 1495.

In the second aspect of the exemplary embodiments, a procedure applicable to cases 2 and 3 is disclosed. As described above, these cases are: case—2 AS-Context established and active between UE and target SpCell, and case 3—AS-Context established and inactive between UE and target SpCell. As described above, the second aspect is random access based, whereas the first aspect is RRC based.

The second aspect may be understood to be applicable to use cases where the UE requires being connected to a target SpCell with the following conditions: AS-context is established between the UE and the target SpCell (but may be active as in case 2, or inactive as in case 3), and the UE context is still maintained on the network side by the last serving SpCell. If the UE context is no longer available on the network side (e.g., racing conditions) then a fallback to connection setup procedure may be utilized.

A first option of the first variant of the second aspect may represent the primary call flow of the second aspect. The second aspect is applicable when AS-security (including security configurations) established and active between the UE and target SpCell. For case 3, the target SpCell AS-context would be applied first before starting the second aspect procedure. The “UE-initiated SpCell Access—RA based” message is allowed as a procedure initiation cause (e.g., handover, connection reset, connection resume).

FIG. 15 depicts a call flow diagram for random access-based UE-Initiated SpCell Access according to various exemplary embodiments. In 1505, the UE 110 sends the target SpCell 1595 a preamble RACH message. In 1510, the target SpCell 1595 responds to the preamble message 1505 with a RAR. In 1515, the UE 110 sends another RACH to the target SpCell 1595, this time containing information identifying the UE “UE short AS-identity” and an SpCell access request via a MAC CE or RRC signaling “RRCSpCellAccessComplete” or by any other suitable means.

In a first option, the message 1515 may be a signaling message, for example, an RRC RRCSpCellAccessComplete message with CRNTI MAC CE included. This may be ciphered and integrity protected using the currently active AS-context security configurations.

In a second option for the message 1515, a new MAC CE called “UE-initiated SpCell Access” having a short AS-identity included may be used. The short AS-identity may be set to a value which should be sufficient because the AS-context is already established with the target SpCell 1595. The message 1515 may also include a cause of procedure initiation (e.g., handover, connection reset, resume).

In 1520, the target SpCell 1595 sends a UE SpCell access request message to the source SpCell 1590. In 1525, the source SpCell 1590 sends a UE SpCell access confirmation message to the target SpCell 1595. In 1530, the target SpCell 1595 sends a contention resolution MAC CE having the same value as the message sent in the message 1515, or the same value as the “UE-initiated SpCell access” MAC CE.

In 1535, the UE 110 completes the UE-initiated SpCell access procedure. The connected mode now uses target SpCell 1595 as the primary serving SpCell. In 1540, target SpCell 1595 sends a message indicating that the UE-initiated SpCell access procedure is complete. Included in this message is the identity of the UE 110.

In a second variant of the second aspect, operations are disclosed covering the scenario in which the target SpCell is highly loaded and unable to serve the UE. In this scenario, the network may move the UE to another SpCell in a first option, or put the UE in an idle/inactive state.

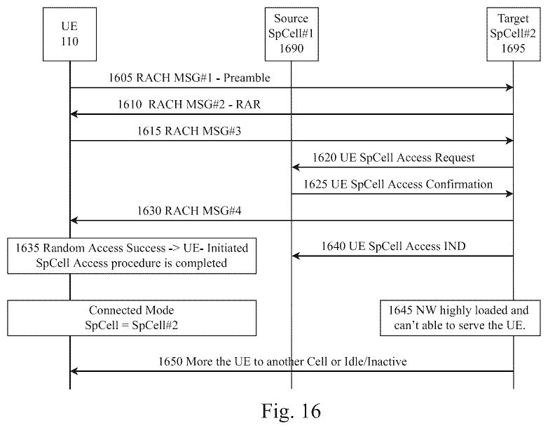

FIG. 16 depicts a call flow diagram for random access based UE-Initiated SpCell Access when a network is highly loaded and cannot serve a UE according to various exemplary embodiments. 1605-1640 proceed identically to 1505-1540 discussed above.

In 1645, the target SpCell 1695 concludes that the network is highly loaded and that the target SpCell 1695 is unable to serve the UE 110. In 1650, the target SpCell 1695 sends a message to the UE 110 indicating that the UE 110 must move to another cell or enter an idle/inactive state. This message 1650 causes RRC release between the UE 110 and the target SpCell 1695.

In a third variant of the second aspect, RRC connected mode handover/PSCell Change for cases 2 and 3 are disclosed. It should again be noted that cases 2 and 3 have UE AS-context established and active between the UE and target cell. It should be further understood that in case 2, the UE AS-context is active and in case 3, the AS-context is inactive. Case 3 may be addressed identically to case 2 below, the only difference being that the target SpCell AS-context would be applied first before starting the Random Access based UE-initiated SpCell access procedure.

A UE change from a source SpCell to target SpCell when the AS-context is already is simplified by the third variant of the second aspect. No AS-context configurations are required for the target SpCell, nor before nor after handover/PSCell Change procedures. Those of skill in the art will understand it is desirable to only use RA procedures to successfully complete the third variant of the second aspect. The operations of the third aspect are similar to NR beam management procedures, wherein switching beams on the same cell is a relatively simple operation that doesn't involve RRC.

Depending on the target SpCell AS-Context, the source SpCell may be considered as an SCell (activated or deactivated) after the change procedure is completed. This may be controlled via network dedicated configurations or industry standards specifications.

The third variant of the second aspect may be used when a UE is operating in an RRC connected mode during a mobility operation to a target SpCell where the AS-context of the UE is established and active (e.g., to one of the UE configured serving cells).

The third variant of the second aspect may improve device latency, since no RRC signaling is required—neither measurement reports nor handover commands are needed. Since serving cells are already configured, no RF re-configuration is required, nor is there a need to change the security context since SCells are already part of the same node. Reliability is improved by the third variant because there is no signaling exchanged with the source SpCell but instead with the target SpCell selected for having better Radio Channel conditions. Another area improved is the minimized handover interruption time. The existing link and data transfer with the source SpCell is maintained, which prevents interruption of user plane data. The third variant also reduces complexity and increases scalability—no handover pre-preparations are required, either on UE side nor on the network side.

Since the AS-context has been already established with the target SpCell, the Random Access based UE-initiated SpCell access may be used. The UE may receive a configuration indication if the Random Access based UE-initiated SpCell access procedure is allowed to be used for a handover/PCell change.

Configurations of the third variant may have configured SCells as part of a list of candidate target SpCells. The configurations may also extend the serving cell configuration (e.g., ServingCellConfig IE in NR). These extensions may include any additional information required to have an SCell become a target SpCell. For example, if an SCell is configured to be DL only, but an UL configuration would be required to have the SCell as candidate SpCell, then the SCell UL configuration would be filled in the SCell configuration (which may be delta on source SpCell). A new field may be added to indicate the SCell type ID as DL_Only and that the UL configuration is to be used only if it becomes an SpCell. Alternatively, source SpCell UL configurations could be reused. It should be understood that all other RRC (security context, measurements, RBs, MAC) may be reused in the third variant of the second aspect.

The execution decision for changing an SpCell to one of the SCells may be achieved by different schemes such as via MeasConfig framework, via a new IE “SpCellChangeMobCond” defining the SpCell Access criteria (e.g., similar to idle mode Reselection configuration). For example, this IE may define the threshold where the SCell connection characteristics are better than the SpCell (e.g., SCell connection has better power characteristics than the source SpCell based on a threshold or delta comparison), or the duration during which the condition should be fulfilled. The execution may also occur via network L1 (e. g., DCI, PDCCH order) or L2 (e. g., MAC CE) triggers or by any other scheme defined by industry standards.

The execution procedure for the third variant is fulfilled when the AS-Context is already established and active for the target SpCell and the UE starts mobility operations to this cell by triggering “UE-Initiated SpCell Access—RA Based” procedure.

Once successfully completed, both the network and the UE configurations are synchronized to the target SpCell configurations. The source SpCell may be considered as an SCell (activated or deactivated) after the change is completed. This may be controlled via network dedicated configurations or industry standard defined operations. Execution may be guarded by an RRC timer. If the timer expires, an RRC abort procedure may be performed and the UE may remain on the current/source SpCell.

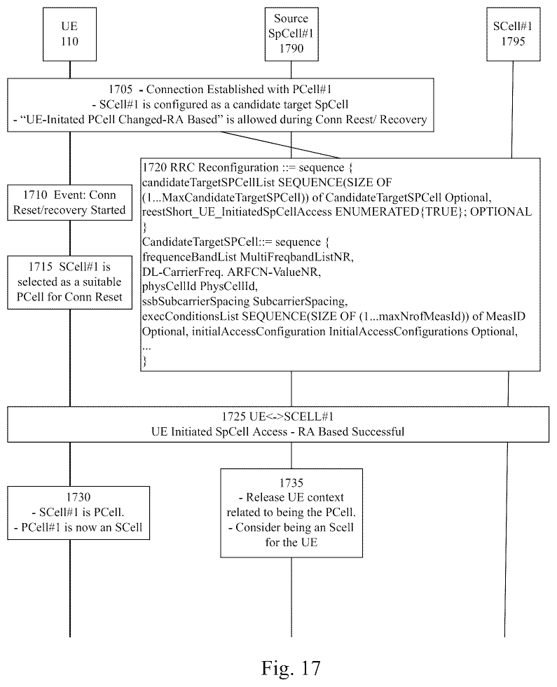

FIG. 17 depicts a call flow diagram for random access-based VE-Initiated SpCell Access for connected mode handover/PSCell Change according to various exemplary embodiments. In 1705, UB 110 has a connection established with source PCell 1790 (which is acting as the SpCell). The UE 110 has target SCell 1795 configured as a candidate target SpCell. The configuration contains an indication that RA based UE-initiated PCell changes are allowed during a connection reset/recovery.

In 1710, an event occurs that requires the UE 110 to perform a connection reset/recovery. In 1715, UE 110 selects SCell 1795 as a suitable PCell for the connection reset. In 1720, the PCell 1790 transmits an RRC reconfiguration message to the UE 110. Included in the message 1720 is a candidate target SpCell list, as well as an IE for reestablishing UE-initiated SPCell access.

In 1725, the UE 110 performs the RA based UE-initiated SpCell access procedure described with respect to FIG. 15. In 1730, the UE 110 treats SCell 1795 as a PCell, and PCell 1790 as an SCell. In 1735, the PCell 1790 (now acting as an SCell) releases the UE context related to being the PCell.

In a fourth variant of the second aspect of the exemplary embodiments RA based UE-initiated SpCell access RRC connection reestablishment/recovery procedures are disclosed. During RRC connection re-establishment, if the selected PCell was one the previously configured serving cells (configured as a candidate target SpCell, if any) or the last serving PCell, then the UE may reestablish the connection on the selected serving cell using the currently active AS-Context (RRC configurations and Security Context). No further configuration is required from the PCell to successfully complete the procedure. The fourth variant of the second aspect is applicable to RRC Connection Reestablishment on one of the previously configured serving cells (SCell) or the last PCell.

The fourth variant reduces the user-plane data transfer suspend time. This reduces RRC signaling and re-uses the AS-Context configurations already established and active between the UE and the network. The configurations used in the fourth variant of the second aspect are the same as described with respect to third variant of the second aspect. Optionally the network may control application of this feature in connection recovery using a new ASN.1 field, “reestShortUE_InitiatedSpCellAccess”.

The execution condition of the fourth variant occurs when the selected suitable PCell is one of the previously configured serving cells that is configured as a candidate target SpCell or the last PCell and the “UE-Initiated SpCell Access—RA Based” procedure is allowed by network during the connection recovery procedure.

The execution procedure of the fourth variant is when executions conditions are fulfilled and AS-Context is already established and active for the target SpCell, the UE starts mobility operations to the target SpCell by triggering the “UE-Initiated SpCell Access—RA Based” procedure. Once the RA procedure is successfully completed, both the network and the UE configurations are now synchronized to the AS-Context that was active before the connection reestablishment. If applicable, the source SpCell may be considered as an SCell (activated or deactivated) after the change is completed. This may be controlled via network dedicated configurations or industry standard defined procedures. Execution may be guarded by an RRC timer. If the timer expires, the UE triggers the connection reestablishment procedure where “UE-Initiated SpCell Access—RA Based” procedure is not allowed.

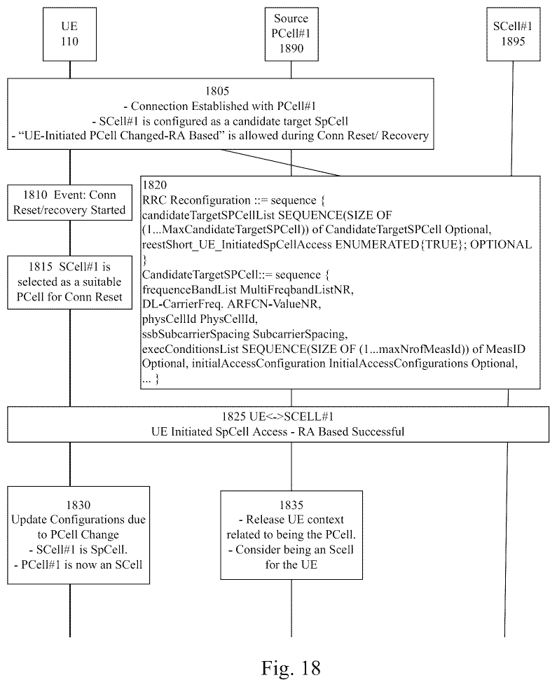

FIG. 18 depicts a call flow diagram for random access-based UE-Initiated SpCell Access for RRC Connection Reestablishment/Recovery according to various exemplary embodiments. 1805-1825 proceed identically to that procedures described with respect to 1705-1725 above.

In 1830, the UE 110 updates configurations due to the PCell change. The SCell 1895 is now the SpCell and PCell 1890 is now an SCell. In 1835, the source PCell 1890 releases the UE context related to being the PCell.

In a fifth variant of the exemplary embodiments, an RRC connection resume operation for case 3 (UE AS-Context established and Inactive Between UE And target SpCell) is disclosed. If an RRC connection resume is required on a serving PCell where AS-Context is already established (e.g., the PCell is the last serving PCell or one of the configured Serving Cells), then the UE can resume the connection directly by applying the stored AS-Context and no further configuration is required from PCell to successfully complete the procedure. Data transfer can start as soon as RA begins.

The fifth variant may be applied for an RRC Connection Resume on the last serving PCell or when one of the configured Serving Cells (SCell) in stored AS-Context or more generally on any PCell where the AS-Context is stored. The fifth variant reduces latency in resuming user-plane data transfer by avoiding the existing connection resume flow and reduces RRC signaling.

The configurations used for the fifth variant are the same as those described with respect to FIG. 17. Optionally, the network may control application of this feature in Connection Resume using the new ASN.1 field, “resumeShortUE_InitiatedSpCellAccess”. The network may configure the state of SCells or the SCG after the connection resume, (Activated or Deactivated).

In the fifth variant, the UE may apply a PCell stored AS-Context. The UE begins the connection resume by triggering the “UE-Initiated SpCell Access—RA Based” procedure. Once RA has been successfully completed, both the network and the UE configurations are now synchronized to the stored AS-Context. If applicable, the Source SpCell or last serving SpCell may be considered as an SCell (activated or deactivated) after the change is completed. This may be controlled via network dedicated configurations or industry standard defined actions. In the case that the network is highly loaded and unable to serve the UE, then the network will not provide grants to UE for data transfer and either release the UE or perform a blind HO of the UE to another cell. Execution would be guarded by RRC timer. If the timer expires, the UE triggers a procedure for moving to an RRC idle state.

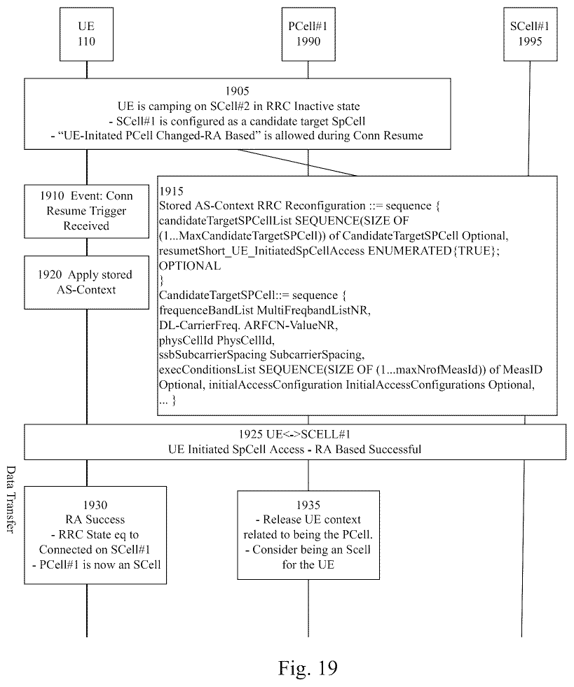

FIG. 19 depicts a call flow diagram for random access-based UE-Initiated SpCell Access for RRC connection resume according to various exemplary embodiments. In 1905, the UE 110 is camping on a PCell 1990 in an inactive state. The SCell 1995 is configured as a candidate target SpCell. The UE 110 has an awareness that the “UE-initiated PCell change—RA based” is allowed during connection resume operations.

In 1910, the connection resume trigger event is received at the UE 110. In 1915, the SCell 1995 transmits the stores AS-Context RRC reconfiguration. Included in the RRC reconfiguration is the new ASN.1“resumetShort_UE_InitiatedSpCellAccess”.

In 1920, the UE 110 applies the stored AS-context. In 1925, UE 110 initiates the “UE-initiated SpCell Access—RA Based” with the SCell 1995. In 1930, the RA procedure is successful and the RRC state of UE 110 changes to connected on SCell 1995, whereas PCell 1990 is now an SCell. In 1935, the PCell 1990 releases the UE 110 context related to being the PCell.

### EXAMPLES

In a first example, a cellular device initiates an RRC Connected mode handover to a target SpCell with which no AS-Context dedicated configurations is pre-configured, after fulfilling conditions that can be configured by the source SpCell or defined by standards, if any.

In a second example, the cellular device of the first example, wherein the cellular device does not need to send any information related to Handover to the source SpCell prior to initiating the procedure to access the target SpCell for Handover.

In a third example, the cellular device of the first example, wherein the source SpCell does not initiate any preparations for the Handover.

In a fourth example, the cellular device of the first example, wherein the cellular device receives the target SpCell AS-Context dedicated configurations directly from the target SpCell air-interface that is security protected (ciphered and integrity protected) via the source SpCell security configurations.

In a fifth example, the cellular device of the first example, wherein no AS Security Authentication is required with the target SpCell.

In a sixth example, the cellular device of the first example, wherein each NodeB/BaseStation has its own security configuration and AS-Context with the cellular device.

In a seventh example, a cellular device initiates RRC Connected mode Connection recovery to a target SpCell with which no AS-Context dedicated configurations is pre-configured, after fulfilling conditions that are defined by standards.

In an eighth example, the cellular device of the seventh example, wherein no AS Security Authentication needs to be first established between the target PCell and the cellular device before the reception of the target PCell AS-Context dedicated configurations.

In a ninth example, the cellular device of the seventh example, wherein the cellular device receives the target SpCell AS-Context dedicated configurations directly from the target PCell air-interface that is security protected (ciphered and integrity protected) via the source SpCell security configurations.

In a tenth example, a cellular device resumes an RRC connection from an Inactive state, with a target SpCell with which no AS-Context dedicated configurations is pre-configured.

In an eleventh example, the cellular device of the tenth example, wherein the cellular Device receives the target PCell AS-Context dedicated configurations directly from the target PCell air-interface that is security protected (ciphered and integrity protected via the source SpCell security configurations.

In a twelfth example, the cellular device of the tenth example, wherein the cellular device does not derive the security context for the target PCell based on configurations received from source PCell at Connection Suspend.

In a thirteenth example, a cellular device establishes and activates AS-Context with a target SpCell in different use cases, Handover Connection or Resume Connection or Reestablish Connection, via a single RRC procedure.

In a fourteenth example, a cellular device indicates support for a UE-Initiated SpCell Access procedure via a UE-Capability message. The SpCell Access procedure may be RRC signaling based or Random Access based.

In a fifteenth example, a network is configured to enable/disable the applicability of a UE-Initiated SpCell Access procedure dynamically via configuration parameters. The SpCell Access procedure may be RRC signaling based or Random Access based. The use cases (comprise handover, PSCell Change, Connection reestablishment or connection resume. The configurations can be provided to the Cellular Device via dedicated or broadcast messages.

In a sixteenth example, a network configures a cellular device with a list of candidate target SpCells for which the cellular device is allowed to initiate connected mode mobility. These configurations can be provided to the Cellular Device via dedicated or broadcast messages. These configurations may include the execution conditions for each target SpCell. Conditions that need to be fulfilled by the cellular device before initiating mobility to the candidate target SpCell. These conditions can be configured per Candidate Target SpCell or general for all target SpCells. If not provided, then SpCell Access criteria defined by 3GPP could be applied (e.g., similar to cell Suitability criteria). This configuration may include the configurations required for initial access for the target SpCell. If not provided by the Cellular Network via dedicated signaling, then the Cellular Device acquires it via target SpCell broadcasted system information. Network configurations could also provide prioritization order for the candidate target SpCells, so in case more than SpCell is fulfilling conditions, then the one having higher priority should be selected. Unlike CHO/CPC, neither pre-RRC dedicated configurations on UE side nor pre-preparations on NW side for the candidate target SpCells is needed.

In a seventeenth example, a network sends special configurations via broadcast messages or dedicated signaling for the UE-initiated cell access procedure. The special configurations have shorter timing configurations. The special configuration use is limited for cellular devices accessing cell for UE-Initiated SpCell Access procedure.

In an eighteenth example, a network broadcasts System Information having only information required by a cellular device for executing Cell Access procedure and reception of Target SpCell RRC signaling message. The System Information could be broadcast more frequently compared to SIB1.

In a nineteenth example, a cellular device initiates mobility to a target SpCell via a UE-Initiated SpCell Access RRC signaling based procedure when target SpCell conditions are fulfilled for UE-Initiated SpCell Access procedure and no AS-Context established for the target SpCell. The cellular device synchronizes on the target SpCell and applies the cellular network access procedure (e.g., Random Access procedure) towards the selected target SpCell. It may be up to UE implementation if disconnection from source SpCell is required or not to perform these operations.

In a twentieth example, a cellular device, when performing a connection recovery procedure, searches for a suitable PCell for a predefined duration, when a suitable target SpCell is found and no AS-Context is established for the target SpCell, the cellular device performs a UE-Initiated SpCell Access—RRC signaling based procedure for the selected target SpCell.

In a twenty first example, a cellular device, when resuming an RRC Connection on a target PCell and no AS-Context established for the target PCell, the cellular device initiates an RRC Connection resume to the target PCell via a UE-Initiated SpCell Access—RRC Signaling based procedure by synchronizing with the target SpCell and applying the cellular network access procedure (e.g., Random Access procedure) towards the selected target PCell.

In a twenty second example, a cellular device, during a cellular network cell access procedure, sends a message (e.g., RA Msg #3) to the target SpCell including information indicating an SpCell Access request associated with a UE identity, example “Long AS-Identity”, that is defining the UE within the Cellular Network and sufficient to allow the target SpCell to retrieve the UE Context from the source SpCell. The UE identity can be the Source SpCell CGI “Cell Global Identity”+CRNTI. The message further comprises additional information such as a cause, defining the cause of the UE Initiated SpCell Access, an RRC prepared Integrity Code verifying some of the information related to UE-Initiated SpCell Access procedure, like source & target SpCells Physical Cell ID and UE RAN Identity (e.g., C-RNTI), similar to short MAC-I or anything else that is defined by 3GPP standards.

In a twenty third example, a target SpCell, when receiving a cellular device SpCell Access request, retrieves the UE Context from the source SpCell using the “Long AS-Identity.” This may include other information received from the UE such as a UE Integrity Code. When the UE Context is successfully retrieved, the target SpCell prepares the air-message to be sent to the UE as a response for SpCell Access request. The air message may include an RRC SpCell Access which provides the UE with its RRC configurations and security context, a request from the source SpCell the UE SpCell Access, “UE SpCell Access Req”, associated with the prepared, by the source SpCell, target SpCell air-message response to the Cellular Device that may be associated with other information like the cellular device RRC prepared Integrity Code. When the UE Context retrieval was not possible, example UE was not found or UE verification fails, the target SpCell prepares the air-message to be sent to the UE as a response for SpCell Access request in transparent container (i. e., without being ciphered or integrity protected). Example for possible responses from target SpCell include an RRC Setup “PCell Change Only”-> Rejecting SpCell Access and setting up new Connection or feedback to the cellular device.

In a twenty fourth example, a source SpCell, when receiving a request for SpCell Access from a target SpCell, stops data exchange with the cellular device, at least signaling data, assesses the request. The source SpCell accepts the SpCell Access and prepares the target SpCell air-message response to the cellular device by integrity protecting and ciphering it using the source SpCell security configurations. The source SpCell performs an RRC Release “PCell Change Only”, then the SpCell Access is rejected and RRC Connection release air-message is prepared and integrity protected and ciphered using the source SpCell security configurations. The source SpCell determines a mobility from X “PCell Change Only”, then the SpCell Access is rejected and RRC mobility to another RAT air-message is prepared and integrity protected and ciphered using the source SpCell security configurations. The source SpCell determines an RRC Reconfiguration, the SpCell Access is rejected and RRC mobility to another SpCell with same RAT air-message is prepared and integrity protected and ciphered using the source SpCell security configurations. Other actions may also be taken such as sending back an SpCell Access confirm, “UE SpCell Access Cnf”, to the target SpCell having an Action, a prepared air-message based on the action and RBs context/state variables information and any other information needs to be handed over to the target SpCell.

In a twenty fifth example, a target SpCell, when receiving a “UE SpCell Access Cnf” from a source SpCell, completes the cellular network initial access procedure (e.g., sending Msg #4), if not already done. For Random Access in 4G/5G, msg #4 ContentionResolution MAC CE shall have part of the content sent by Cellular Device in Msg #3. Example, RRC Signaling air-message or “UE-Initiated SpCell Access” MAC-CE.-Sends air-message response to the Cellular Device prepared by the source SpCell that is ciphered and integrity protected by source SpCell security configurations.

In a twenty sixth example, a cellular device, when the Cellular Network initial access procedure (e.g., RA) is successful on a target SpCell, disconnects from source SpCell, if was not done already (e.g., if UE didn't already disconnect from source SpCell to initiate Network access procedure), and resets MAC and suspend all RBs except signaling RBs used for communication with target SpCell (e.g., SRB0 & 1) In a twenty sixth example, a cellular device, when receiving the first target SpCell signaling air-message after Cellular Network access procedure success (e.g., RA success), considers the UE-Initiated SpCell Access procedure complete. The cellular device, when receiving feedback via non-secured signaling radio bearer (e.g., SRB0), perform actions based on the received air-message. The cellular device, when receiving feedback via secured signaling radio bearer (e.g., SRB1), decipher and integrity verify the message received from the target SpCell via the source SpCell security configurations. The cellular device, when the access procedure fails, performs an RRC Connection release procedure. The cellular device, when the access procedure succeeds, perform actions based the received air-message. If air-message is “RRCSpCellAccess”, then the cellular device applies configurations (including security context), resume RBs or other activities defined by standard and sends a response air-message to the target SpCell, example “RRCSpCellAccessComplete”. The air-message is integrity protected and ciphered using the target SpCell security configurations.

In a twenty seventh example, a cellular device, when a UE-Initiated SpCell Access procedure guard timer expires, the cellular device remains connected to source SpCell if not not disconnected from the source SpCell (like in DAPS feature). When the procedure was initiated due to Connection recovery, the cellular device performs the RRC Connection release procedure, When the procedure was not initiated due to Connection recovery, for a Master Cell Group, initiate Connection Recovery procedure and for a Secondary Cell Group, initiate Cell Group recovery procedure.

In a twenty eighth example, a cellular device initiates an RRC Connected mode Handover, example PCell Handover or PSCell Change, to a target SpCell with which an AS-Context dedicated configurations (e.g., security config, RBs config, Meas Config) is established and active. The cellular device considers the handover complete upon successful Cellular Cell Access Procedure (e.g., RA procedure in 4G/5G). No AS-Context dedicated configurations need to be provided to the Cellular Device, neither from the source SpCell nor from the target SpCell to successfully complete this procedure. The Cellular Device need not to send any information (e.g., Measurement Reports) related to Handover to the source SpCell prior to initiating this procedure accessing the target SpCell for Handover. The Source SpCell does not initiate any preparations for the Handover. No AS Security Authentication required with the target SpCell. Data transfer with target SpCell may be resumed with the start of Cellular Cell Access Procedure.

In a twenty ninth example, a cellular device initiates RRC Connected mode connection recovery, example Connection Reestablishment, to a target SpCell with which an AS-Context dedicated configurations (e.g., security config, RBs config, Meas Config, . . . ) is established and active. The cellular device considers the connection recovery complete upon successful Cellular Cell Access Procedure (e.g., RA procedure in 4G/5G). No AS Security Authentication needs to be first established between the target SpCell and the Cellular Device to successfully complete this procedure. No AS-Context dedicated configurations need to be provided to the Cellular Device, neither from the source SpCell nor from the target SpCell to successfully complete this procedure. Data transfer with target SpCell may be resumed with the start of Cellular Cell Access Procedure.

In a thirtieth example, a cellular device resumes an RRC Connection, example from Inactive state, to a target PCell with which an AS-Context dedicated configurations (e. g., security config, RBs config, Meas Config) is already established. The cellular device considers the connection resume complete upon successful Cellular Cell Access Procedure (e.g., RA procedure in 4G/5G). No further dedicated configurations need to be provided to the Cellular Device from the target SpCell to successfully complete this procedure. Data transfer may be resumed with the start of Cellular Cell Access Procedure.

In a thirty first example, a cellular device, when a candidate target SpCell conditions are fulfilled for UE-Initiated SpCell Access procedure execution and AS-context is already established & active for the selected target SpCell and “UE-Initiated SpCell Access RA-based” is allowed by the network for RRC Connected mobility use case, the cellular device performs a “UE-Initiated SpCell Access—RA Based” procedure via initiating Cellular Network access procedure (e.g., Random Access procedure) towards the selected target SpCell.

In a thirty second example, a cellular device, applies the Connection Recovery procedure, example Connection Reestablishment, the cellular device searches for a suitable PCell for a predefined duration. When a suitable target SpCell found and AS-Context established and active for the target SpCell and “UE-Initiated SpCell Access RA-based” is allowed by the network for RRC Connection Reestablishment use case, the cellular device performs a “UE-InitiatedSpCellAccess-RABased”procedureviainitiatingCellularNetworkaccessprocedure, (e.g., Random Access procedure) towards the selected target SpCell. Data transfer may start as early as the start of Cellular Cell Access Procedure.

In a thirty third example, a cellular device, when a cellular device requires resuming the RRC Connection with a target PCell and AS-context is already established for the target PCell (i.e., PCell on which Connection to be resumed) and “UE-Initiated SpCell Access RA-based” is allowed by the Network for RRC Connection Resume use case, the cellular device applies the target PCell stored UE-Context configurations and performs a “UE-Initiated SpCell Access—RA Based” procedure via initiating Cellular Cell Access Procedure (e.g., Random Access procedure) towards the selected target SpCell. Data transfer may start as early as the start of Cellular Cell Access Procedure.

In a thirty fourth example, a cellular device when initiating Cellular Network Cell access procedure (e.g., RA Msg #3) to the target SpCell, the cellular device includes information indicating that the cellular device requires being Connected to target SpCell, SpCell Access request associated with UE identity, “Short AS-Identity”, that is identifying the UE at the target SpCell or an identity that is sufficient for the target SpCell to be able to identify the cellular device, example could be named “Short AS-Identity.” The “Short AS-Identity” value could be different based on the procedure cause, e.g., could be C-RNTI for Handover UCs but could be different. value for Connection Reestablishment/Recovery & Resume UCs. The message may also include cause, defining the cause of the UE Initiated SpCell Access, e.g., Handover or Connection Reestablishment/Recovery or Connection Resume, secured RRC signaling air-message, example RRCSpCellAccessComplete, having information described above and UE Identity indicated by MAC-CE. The message will be secured (e.g., ciphered and integrity protected) using the current active AS-context security configurations or a new “UE-Initiated SpCell Access” MAC-CE having information described above.

In a thirty fifth example, a target SpCell, when a source and the target SpCell are different, when the target SpCell receives the Cellular Device SpCell Access request, the target SpCell requests from the source SpCell the UE SpCell Access, “UE SpCell Access Req” using the “Short AS-Identity.”

In a thirty sixth example, a source SpCell, when the source and a target SpCell are different, when the source SpCell receives a request for SpCell Access from target SpCell, the source SpCell considers itself as an SCell, activated or deactivated, based on UE-Initiated SpCell Access procedure configurations provided to the cellular device or default actions specified in standards and sends back an SpCell Access confirm, “UE SpCell Access Cnf”, to the target SpCell.

In a thirty seventh example, a target SpCell, when a source and the target SpCell are different, when the target SpCell receives the “UE SpCell Access Cnf” from source SpCell, the target SpCell completes the Cellular Network initial access procedure (e.g., sending Msg #4). Example for 4-step Random Access in 4G/5G, Msg #4 ContentionResolution MAC CE shall have part of the content sent by the Cellular Device in Msg #3 (e.g., RRC Signaling air-message or “UE-Initiated SpCell Access” MAC-CE).

In a thirty seventh example, a target SpCell when a source and the target SpCell are the same, when the target SpCell receives the Cellular Device SpCell Access request, the target SpCell completes the Cellular Network initial access procedure (e.g., sending Msg #4). Example for 4-step Random Access in 4G/5G, Msg #4 ContentionResolution MAC CE shall have part of the content sent by the Cellular Device in Msg #3 (e.g., RRC Signaling air-message or “UE-Initiated SpCell Access” MAC-CE).

In a thirty eighth example, a cellular device, when the cellular network initial access procedure (e.g., RA) is successfully completed on a target SpCell, the cellular device considers that a UE-Initiated SpCell Access procedure is successfully completed, the target SpCell becomes a current SpCell (i.e., PCell for MCG, PSCell for SCG), the source SpCell becomes an SCell, activated or deactivated, based on configurations received from the network or default action specified in standards.

In a thirty eighth example, a cellular device, when a UE-Initiated SpCell Access procedure Guard timer expires, the cellular device, when a cause is handover, stops Cell Network Access procedure to the selected target SpCell and remains connected to the source SpCell and when the cause is not handover, releases the connection.

In a thirty ninth example, a method performed by a user equipment (UE), wherein the UE has an established Access Stratum (AS) context with a target SpCell, the method comprising transmitting a message to the target SpCell, the message comprising a UE identity and an SpCell access request and receiving an SpCell access response indicating the target SpCell is now the serving cell for the UE.

In a fortieth example, the method of the thirty ninth example, wherein the message is ciphered and integrity protected using a security context of the target SpCell.

In a forty first example, the method of the fortieth example, wherein the SpCell access response comprises a same value as the message.

In a forty second example, the method of the thirty ninth example, wherein the message is a medium access control-control element (MAC-CE) comprising the UE identity that identifies a security context of the target SpCell.

In a forty third example, the method of the forty second example, wherein the SpCell access response comprises contention resolution MAC-CE corresponding to the MAC-CE of the message.

In a forty fourth example, the method of the thirty ninth example, further comprising receiving, from the target SpCell, a connection release message comprising an indication that (i) the UE should transition to an idle or inactive state with the target SpCell or (ii) perform a mobility operation to a different candidate SpCell.

In a forty fifth example, the method of the thirty ninth example, further comprising receiving, from a currently serving SpCell, a list comprising candidate SpCells, measurement parameters for each of the candidate SPCells and thresholds for the measurement parameters, determining a connection reestablishment procedure or a connection recovery procedure is to be performed and measuring the measurement parameters for each of the candidate SPCells, wherein the target SpCell for the connection reestablishment procedure or connection recovery procedure is selected based on a measured value satisfying at least one of the thresholds for the measurement parameters.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above-described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by a base station operating as a target special cell (SpCell) for a user equipment (UE), comprising:
receiving a message from the UE comprising a UE identity and an SpCell access request;
transmitting a UE context request comprising the UE identity to a currently serving SpCell; and
receiving a UE context reply from the currently serving SpCell.

2. The method of claim 1, wherein the UE context reply comprises a context of the UE.

3. The method of claim 2, further comprising:
transmitting, to a currently serving SpCell, a UE SpCell access request comprising the UE identity; and
receiving a UE SpCell access confirmation from the currently serving SpCell.

4. The method of claim 3, further comprising:
transmitting an SpCell access message to the UE, wherein the SpCell access message is ciphered and integrity protected using a source SpCell security context.

5. The method of claim 3, further comprising:
receiving an RRC SpCell access confirmation message from the UE, wherein the RRC SpCell access confirmation message is ciphered and integrity protected using a target SpCell security context.

6. The method of claim 3, wherein the target SpCell does not receive a response to the SpCell access request within a predetermined time, the method further comprising:
transmitting a failure message to the currently serving SpCell indicating the UE failed to respond to the SpCell access request.

7. The method of claim 3, wherein the UE SpCell access confirmation comprises an indication that the currently serving SpCell has released a connection with the UE, the method further comprising:
transmitting a connection release message to the UE, wherein the connection release message is ciphered and integrity protected using a source SpCell security context.

8. The method of claim 3, wherein the UE SpCell access confirmation comprises an indication that the target SpCell is to perform a connection reconfiguration with synchronization or a mobility operation, the method further comprising:
transmitting a connection reconfiguration message to the UE comprising a synchronization indication or a mobility indication, wherein the connection reconfiguration message is ciphered and integrity protected using a source SpCell security context.

9. The method of claim 1, wherein the UE context reply indicates the currently serving SpCell cannot provide a context of the UE, the method further comprising:
preparing a radio resource connection (RRC) setup for a new RRC connection; and
transmitting an RRC setup message to the UE, wherein the RRC setup message is transmitted via an unsecured channel.

10. The method of claim 1, wherein the UE context request further comprises UE integrity code and wherein the UE context reply indicates the currently serving SpCell cannot provide a context of the UE, the method further comprising:
preparing a radio resource connection (RRC) setup for a new RRC connection; and
transmitting an RRC setup message to the UE, wherein the RRC setup message is transmitted via an unsecured channel.

11. A method performed by a user equipment (UE), comprising:
transmitting a first message to a target special cell (SpCell), the first message comprising a UE identity and an SpCell access request;
receiving a second message from the target SpCell, wherein the second message is ciphered and integrity protected using a source SpCell security context;
deciphering and integrity verifying the second message; and
performing an operation indicated in the second message.

12. The method of claim 11, wherein the second message comprises a connection release message.

13. The method of claim 11, wherein the second message comprises a synchronization indication or a mobility indication.

14. The method of claim 11, further comprising:
receiving, from a currently serving SpCell, a list comprising candidate SpCells, measurement parameters for each of the candidate SPCells and thresholds for the measurement parameters; and
measuring the measurement parameters for each of the candidate SPCells, wherein the target SpCell is selected based on a measured value satisfying at least one of the thresholds for the measurement parameters.

15. The method of claim 11, further comprising:
receiving, from a currently serving SpCell, a list comprising candidate SpCells and criteria for selecting each of the candidate SPCells; and
determining the target SpCell satisfies at least one of the criteria.

16. The method of claim 11, further comprising:
storing a list comprising candidate SpCells and criteria for selecting each of the candidate SPCells; and
determining the target SpCell satisfies at least one of the criteria.

17. The method of claim 11, further comprising:
determining a connection reestablishment procedure is to be performed; and
selecting the target SpCell to perform the connection reestablishment procedure.

18. The method of claim 11, wherein the UE is currently camped on the target SpCell in an inactive state, the method further comprising:
determining a connection resume procedure is to be performed.

19. A method performed by a user equipment (UE), wherein the UE has an established Access Stratum (AS) context with a target special cell (SpCell), the method comprising:
transmitting a message to the target SpCell, the message comprising a UE identity and an SpCell access request; and
receiving an SpCell access response indicating the target SpCell is now a serving cell for the UE.

20. The method of claim 19, wherein the message is ciphered and integrity protected using a security context of the target SpCell.
